(19) United States
(12) Patent Application Publication
(10) Pub. No.: US 2014/0043845 A1
(43) Pub. Date: Feb. 13, 2014

(54) LIGHT-EMITTING APPARATUS

(71) Applicants: Cheng-Yen Chen, Tainan City (TW); Kuan-Wen Chen, Tainan City (TW)

(72) Inventors: Cheng-Yen Chen, Tainan City (TW); Kuan-Wen Chen, Tainan City (TW)

(73) Assignee: Genesis Photonics Inc., Tainan City (TW)

(21) Appl. No.: 13/794,801

(22) Filed: Mar. 12, 2013

(30) Foreign Application Priority Data
Aug. 13, 2012 (TW) 101129229

(51) Int. Cl. F21V 8/00

(52) U.S. Cl. CPC G02B 6/0011
USPC 362/555

(57) ABSTRACT

A light-emitting apparatus including a light guide unit, at least one light-emitting component, and a wavelength conversion unit is provided. The light guide unit has a first end and a second end opposite to the first end. The light-emitting component is disposed on the first end and emits a first light. The wavelength conversion unit is disposed on the second end. The light guide unit guides the first light emitted by the light-emitting component from the first end to the second end, and the wavelength conversion unit converts the first light into the second light, wherein the wavelength of the first light is different from the wavelength of the second light.

### CROSS-REFERENCE TO RELATED APPLICATION

This application claims the priority benefit of Taiwan application serial no. 101129229, filed on Aug. 13, 2012. The entirety of the above-mentioned patent application is hereby incorporated by reference herein and made a part of this specification.

### BACKGROUND

1. Technical Field

The invention is related to a light-emitting apparatus.

2. Description of Related Art

Along with the development of optoelectronic technology, the mechanism of a light-emitting component for emitting light is developed from a thermoluminescence to an electroluminescent (EL). A light-emitting component utilizing the electroluminescent mechanism usually has a narrower light emitting wavelength range. In order to emit light of different colors or light having wider wavelength range, phosphor is commonly utilized to convert the wavelength of light emitted by the light-emitting component.

In a conventional light-emitting apparatus, phosphor is usually applied over the light-emitting component, such that light emitted by the light-emitting component passes through the phosphor and is converted into light having different wavelength by the phosphor. However, the efficiency of the phosphor for converting the wavelength is easily reduced due to heat. The phosphor applied over the light-emitting component is affected by the heat generated while the light-emitting is on. As such, a chromatic shift and a brightness reduction are produced.

A light-emitting diode is one of the light-emitting components that adopt the electroluminescence mechanism. The light-emitting diode has high directivity, that is, light emitted by the light-emitting diode propagates toward a specific direction. Furthermore, the light-emitting diode is often connected to a circuit driving module (i.e., circuit board) externally. Therefore, it is difficult to produce a light source that is omni-directional.

Furthermore, in addition to the light-emitting component of electroluminescent, other light-emitting mechanisms adapted with phosphor are in the condition that the working temperature of the light-emitting component can affect the conversion efficiency of the phosphor easily.

### SUMMARY OF THE DISCLOSURE

The embodiment of the invention set forth a light-emitting apparatus, which has steady and good light-emitting brightness and color.

An embodiment of the invention set forth a light-emitting apparatus, which includes a light guide unit, at least one light-emitting component, and a wavelength conversion unit. The light guide unit has a first end and a second end opposite to the first end. The light-emitting component is disposed on the first end, and emits a first light. The wavelength conversion unit is disposed on the second end. The light guide unit guides the first light emitted by the light-emitting component from the first end to the second end, and the wavelength conversion unit converts the first light into a second light, wherein a wavelength of the first light is different from a wavelength of the second light.

In the embodiment of the invention, a first light emitted by a light-emitting component is guided to a wavelength conversion unit through a light guide unit, and the light guide unit is disposed between the light-emitting component and the wavelength conversion unit. Therefore, it is difficult for heat generated while the light-emitting component is on to transfer to the wavelength conversion unit. Thus, the conversion efficiency of the wavelength conversion unit is less likely reduced due to the heat, so that the light-emitting apparatus of the embodiment of the invention has steady and good light-emitting brightness and color.

In order to make the aforementioned features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a cross-sectional diagram illustrating a light-emitting apparatus according to an embodiment of the invention.

FIG. 2 is a diagram illustrating an alternative light emitting surface of the light guide body illustrated in FIG. 1.

FIG. 3 is a cross-sectional diagram illustrating a light-emitting apparatus according to another embodiment of the invention.

FIG. 4 is a cross-sectional diagram illustrating a light-emitting apparatus according to yet another embodiment of the invention.

FIG. 5 is a cross-sectional diagram illustrating a light-emitting apparatus according to yet another embodiment of the invention.

FIG. 6 is a three-dimensional diagram illustrating a light-emitting apparatus according to another embodiment of the invention.

### DESCRIPTION OF EMBODIMENT

Reference will now be made in detail to the present preferred embodiments of the invention, examples of which are illustrated in the accompanying drawings. Wherever possible, the same reference numbers are used in the drawings and the description to refer to the same or like parts.

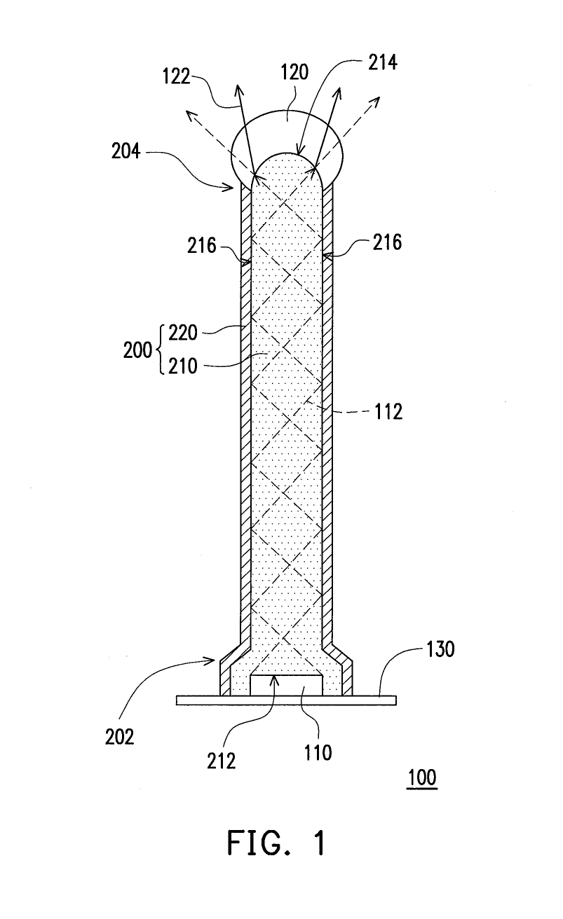

FIG. 1 is a cross-sectional diagram illustrating a light-emitting apparatus according to an embodiment of the invention. With reference to FIG. 1, a light-emitting apparatus 100 in this embodiment includes a light guide unit 200, at least one light emitting component 110 (FIG. 1 uses one light-emitting component 110 as example), and a wavelength conversion unit 120. The light guide unit 200 has a first end 202 and a second end 204 opposite to the first end 202. The light-emitting component 110 is disposed on the first end 202, and emits a first light 112. The wavelength conversion unit 120 is disposed on the second end 204. The light guide unit 200 guides the first light 112 emitted by the light-emitting component 110 from the first end 202 to the second end 204. The wavelength conversion unit 120 converts the first light 112 into a second light 122, wherein a wavelength of the first light 112 differs from a wavelength of the second light 122.

In the embodiment of the invention, the light guide unit 200 includes a light guide body 210, and the first light 112 is capable of being transmitted within the light guide body 210. In the embodiment, the light guide body 210 is a light guide rod, such as a transparent light guide rod. Furthermore, the light guide body 210 has a light incident surface 212, a light emitting surface 214 opposite to the light incident surface 212, and a side surface 216 connecting the light incident surface 212 and the light emitting surface 214, wherein the light incident surface 212 is located at the first end 202, the light emitting surface 214 is located at the second end 204, and the light guide rod extends from the first end 202 to the second end 204.

Furthermore, in the embodiment, the light guide unit 200 further includes a reflective component 220, which encompasses the light guide body 210 and exposes the light guide body 210 at the first end 202 and the second end 204. For instance, the reflective component 220 is disposed on the side surface 216 of the light guide body 210, and the reflective component 220 is a reflective layer of the light guide body 210, such as a reflecting coating layer. After the first light 112 emitted by the light-emitting component 110 enters the light guide body 210 through the light incident surface 212, the first light 112 is reflected continuously by the reflective component 220, and then emits from the light emitting surface 214 of the light guide body 210. Therefore, the light guide unit 200 may certainly transmit the first light 112 from the first end 202 to the second end 204.

In the embodiment, the light-emitting component 110 is a light-emitting diode, and the wavelength conversion unit 120 is a phosphor. For instance, the first light 112 emitted by the light emitting device 110 is, for example, a blue light. The wavelength conversion unit 120, for example, converts the first light 112 that is blue into the second light 122 that is yellow. Thus, the second light 122 emitted from the wavelength conversion unit 120 and the first light 112 that has not been converted by the wavelength conversion unit 120 may blend into a white light. The colors of the first light 112 and the second light 122 of the embodiment described above are for exemplary illustrations, and the first light 112 and the second light 122 may be light having other colors in other embodiments.

In the light-emitting apparatus 100 of the embodiment, the first light 112 emitted from the light-emitting component 110 is guided to the wavelength conversion unit 120 by the light guide unit 200. In addition, the light guide unit 200 is disposed between the light-emitting component 110 and the wavelength conversion unit 120. Therefore, heat generated by the light-emitting component 110 while the light-emitting component 110 is on may not be easily transferred to the wavelength conversion unit 120. Thus, while the light-emitting apparatus 100 is on, a temperature of the wavelength conversion unit 120 may be lower. Therefore, the conversion efficiency of the wavelength conversion unit 120 is less likely reduced due to the heat, so that the light-emitting apparatus 100 of the embodiment has steady and good light-emitting brightness and color.

Additionally, a directivity of the second light 122 is lower, where the second light 122 is converted by the wavelength conversion unit 120. Therefore, a directivity of the light-emitting apparatus 100 may also be reduced. In other words, a light emitted by the light-emitting apparatus 100 may be widely illuminated in every angle.

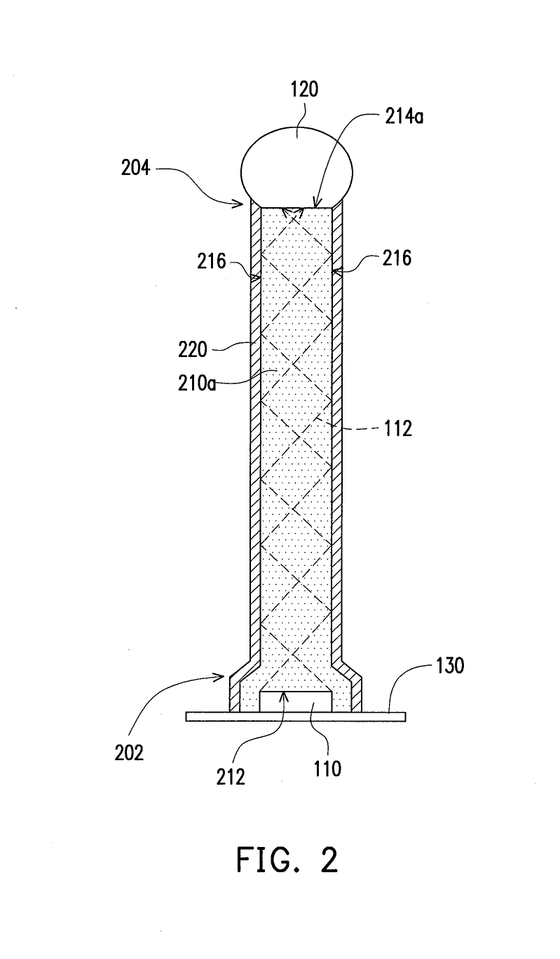

In the embodiment, the light emitting surface 214 of the light guide body 210 is a curved surface, and the curved surface may be utilized to adjust a light-emitting pattern of the first light 112. In the embodiment, the light emitting surface 214 utilizes a convex surface as an example. However, in other embodiment, the light emitting surface 214 may be a concave surface. In another embodiment, a light emitting surface 214a of a light guide body 210a may be a plane as illustrated in FIG. 2.

Moreover, in the embodiment, the light-emitting apparatus 100 further includes a base 130, and the light emitting device 110 and the light guide unit 200 are disposed on the base 130. The base 130 is utilized for heat dissipation and fastening.

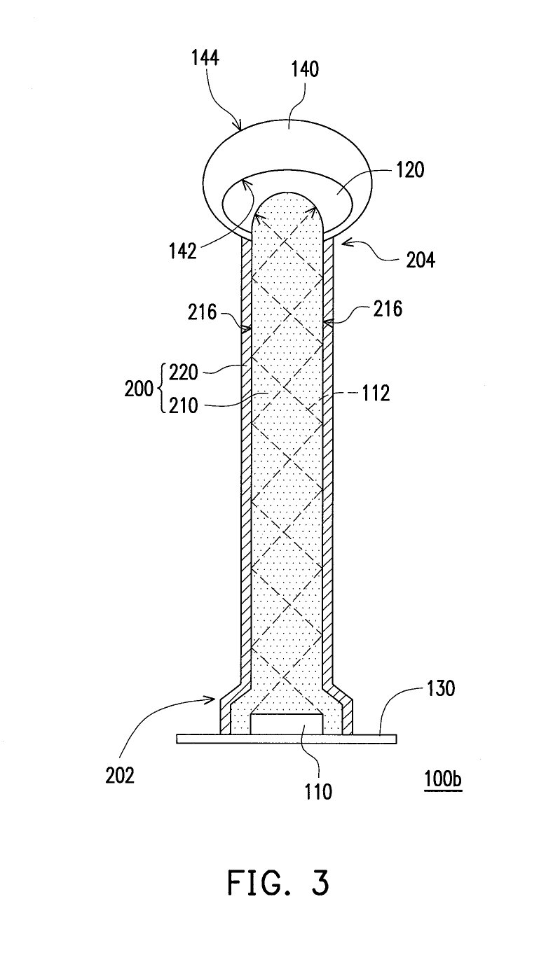

FIG. 3 is a cross-sectional diagram illustrating a light-emitting apparatus according to another embodiment of the invention. With reference to FIG. 3, a light-emitting apparatus 110b of the embodiment is similar to the light-emitting apparatus 100 illustrated in FIG. 1, and the difference between the two are described in the following. With reference to FIG. 3, the light-emitting apparatus 100b in this embodiment further includes a diffuser 140, which is disposed at the second end 204, and covers the wavelength conversion unit 120. For example, the diffuser 140 is, for example, a light transmissive container having a rough surface, which may accommodate the wavelength conversion unit 120, and a roughness Rₐ of the rough surface falls within a range of 0.2 micrometers (μm) to 20 μm. Furthermore, at least one of an inner surface 142 and an outer surface 144 of the diffuser 140 is the rough surface described above. The roughness Rₐ of the diffuser 140 is greater than 0.2 μm to have a light diffusing effect, and more difficult for a user to see the shape and color of the wavelength conversion unit 120 directly when the light-emitting apparatus 100b is off. Moreover, the roughness Rₐ of the diffuser 140 is less than 20 μm, so that no excessive light are consumed due to the diffuser 140 when the light-emitting apparatus 100b is on. Furthermore, when the light-emitting apparatus 100b is on, the diffuser 140 may diffuse the first light 112 that has not been converted by the wavelength conversion unit 120, so that the first light 112 may emit upward as well as downward from the second end 204. Thus, the overall directivity of the light-emitting apparatus 100b may be reduced effectively, so as to cause the light emitted by the light-emitting apparatus 100b to be emitted widely in every different angle.

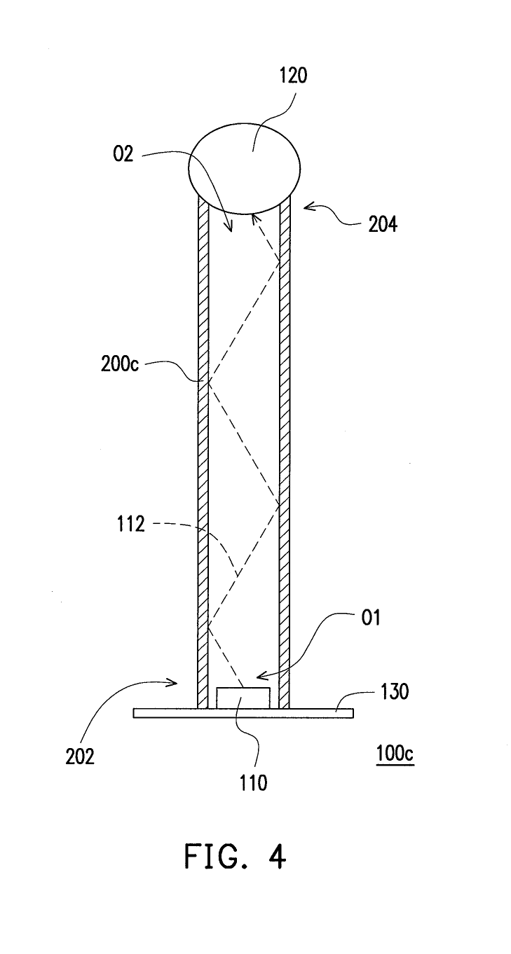

FIG. 4 is a cross-sectional diagram illustrating a light-emitting apparatus according to another embodiment of the invention. With reference to FIG. 4, a light-emitting apparatus 100c of the embodiment is similar to the light-emitting apparatus 100 illustrated in FIG. 1, and the difference between the two is described below. In the light-emitting apparatus 100c of the embodiment, a light guide unit 200c is a hollow reflective cover, which has two openings O1 and O2 located at the first end 202 and the second end 204, respectively. In the embodiment, the hollow reflective cover is a hollow reflective tube, which extends from the first end 202 to the second end 204. The first light 112 emitted by the light-emitting component 110 is transmitted to the second end 204 from the first end 202 and to the wavelength conversion unit 120 through the opening O2. The light guide unit 200c of the embodiment may effectively transmit the first light 112 to the second end 204 from the first end 202.

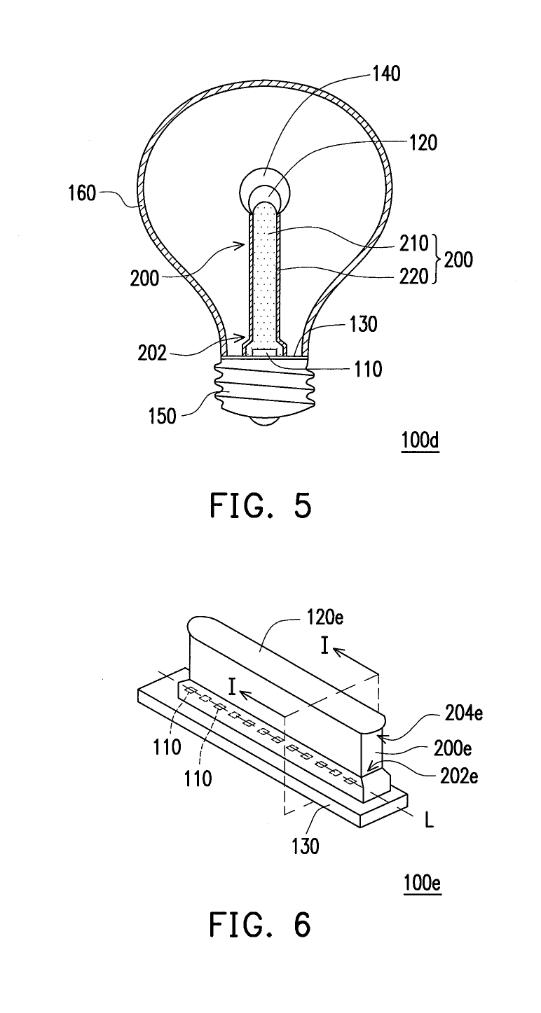

FIG. 5 is a cross-sectional diagram illustrating a light-emitting apparatus according to yet another embodiment of the invention. With reference to FIG. 5, a light-emitting apparatus 100d of the embodiment is similar to the light-emitting apparatus 100b illustrated in FIG. 3, and the difference between the two is described below. The light-emitting apparatus 100d of the embodiment further includes a lamp cap 150 and a light transmissive lamp housing 160. The lamp cap 150 is disposed next to the first end 202, and is electrically connected to the light-emitting component 110. The light transmissive lamp housing 160 is disposed on the lamp cap 150, and covers the light guide unit 200, the light-emitting component 110, and the wavelength conversion unit 120. In the embodiment, the light transmissive lamp housing 160 is a transparent lamp housing, and covers the diffuser 140. However, in another embodiment, the light transmissive lamp housing 160 may be a lamp housing having frosted surface. The light-emitting apparatus may choose not to utilize the diffuser 140, because a lamp housing having frosted surface may achieve a diffusion effect.

FIG. 6 is a three-dimensional diagram illustrating a light-emitting apparatus according to another embodiment of the invention. With reference to FIG. 6, a light-emitting apparatus 100e of the embodiment is similar to the light-emitting apparatus 100 illustrated in FIG. 1. A cross section of the light-emitting apparatus 100e at a cross-section I-I of FIG. 6 is identical as the light-emitting apparatus 100 depicted in FIG. 1, and the difference between the light-emitting apparatus 100e of FIG. 6 and the light-emitting apparatus 100 in FIG. 1 is described below. The light-emitting apparatus 100e of the embodiment has a plurality of light-emitting components 110. The light-emitting components 110 are arranged along a straight line L on a first end 202e of a light guide unit 200e, and the light guide unit 200e is a light guide plate. Moreover, a wavelength conversion unit 120e extends along in a direction that is parallel to the straight line L on a second end 204e of the light guide unit 200e. Thus, the light-emitting apparatus 100 may form a linear light source.

In summary, in the light-emitting apparatus of the embodiment of the invention, the first light emitted by the light-emitting component is guided to the wavelength conversion unit through the light guide unit, and the light guide unit is disposed between the light-emitting component and the wavelength conversion unit. Therefore, heat generated while the light-emitting component is on is not easily transferred to the wavelength conversion unit. Thus, the conversion efficiency of the wavelength conversion unit is less likely reduced due to the heat, so that the light-emitting apparatus of the embodiment of the invention have steady and good light-emitting brightness and color.

Although the invention has been described with reference to the above embodiments, however, the invention is not limited thereto. It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A light-emitting apparatus, comprising:
a light guide unit, having a first end and a second end opposite to the first end;
at least one light-emitting component, disposed on the first end, and emitting a first light; and
a wavelength conversion unit, disposed on the second end, wherein the light guide unit guides the first light emitted by the light-emitting component to the second end from the first end, the wavelength conversion unit converts the first light into a second light, and a wavelength of the first light is different from a wavelength of the second light.

2. The light-emitting apparatus as claimed in claim 1, wherein the light guide unit comprises a light guide body, and the first light is capable of being transmitted within the light guide body.

3. The light-emitting apparatus as claimed in claim 2, wherein the light guide unit further comprises a reflective component, encompassing the light guide body and exposing the light guide body at the first end and the second end.

4. The light-emitting apparatus as claimed in claim 2, wherein the light guide body is a light guide rod.

5. The light-emitting apparatus as claimed in claim 2, wherein the light guide body is a light guide plate, the at least one light-emitting component is a plurality of light-emitting components, arranged along a straight line on the first end, and the wavelength conversion unit extends along a direction parallel to the straight line on the second end.

6. The light-emitting apparatus as claimed in claim 2, wherein the light guide body has a light-emitting surface, located at the second end, and the light-emitting surface is a curved surface or a plane.

7. The light-emitting apparatus as claimed in claim 2, wherein the light guide unit is a hollow reflective cover, having two openings located at the first end and the second end, respectively.

8. The light-emitting apparatus as claimed in claim 1, further comprising a diffuser, disposed at the second end, and covering the wavelength conversion unit.

9. The light-emitting apparatus as claimed in claim 8, wherein the diffuser has a rough surface, a roughness Rₐ of the rough surface falls within a range of 0.2 μm to 20 μm.

10. The light-emitting apparatus as claimed in claim 1, wherein the light-emitting component is a light-emitting diode.

11. The light-emitting apparatus as claimed in claim 1, wherein the wavelength conversion unit is a phosphor.

12. The light emitting apparatus as claimed in claim 1, further comprising:
a lamp cap, disposed next to the first end, and electrically connected to the light-emitting component; and
a light transmissive lamp housing, disposed on the lamp cap, and covering the light guide unit, the light-emitting component, and the wavelength conversion unit.

13. The light emitting apparatus as claimed in claim 12, wherein the light transmissive lamp housing is a transparent lamp housing.

14. The light-emitting apparatus as claimed in claim 12, wherein the light transmissive lamp housing is a lamp housing having frosted surface.
